(19) United States
(12) Patent Application Publication
(10) Pub. No.: US 2007/0188483 A1
(43) Pub. Date: Aug. 16, 2007

(54) Display apparatus for outdoor signs and related system of displays and methods of use

(75) Inventor: James L. Bonner, Mobile, AL (US)

Correspondence Address: STAAS & HALSEY LLP, SUITE 700, 1201 NEW YORK AVENUE, N.W., WASHINGTON, DC, 20005, US

(73) Assignee: The Samson Group, LLC, Mobile, AL (US)

(21) Appl. No.: 11/699,581

(22) Filed: Jan. 30, 2007

Related U.S. Application Data
(60) Provisional application No. 60/762,888, filed on Jan. 30, 2006.

(51) Int. Cl. G09G 5/00

(52) U.S. Cl. 345/204

(57) ABSTRACT

An apparatus, systems and corresponding methods for a network of outdoor modular signs. Each outdoor sign is composed of various modules which combined make the sign fully contained and operable. Modules include paper-like displays, a wireless port, solar panels, battery packs and a frame. A network of such modular signs is placed within an outdoor area. A wireless station is provided with satellite link for receiving data where said data is presented as scheduled on the electronic paper-like display modules. Solar panel and/or battery pack modules power the displays. The outdoor modular sign is suitable for deployment in parking lots and other outdoor areas where a network of signs can be deployed in close proximity to each other providing engaging advertisement and messages to consumers walking through the defined outdoor areas.

### CROSS-REFERENCE TO RELATED APPLICATION

This application claims the benefit, under 35 U.S.C. §119(e), of U.S. Provisional Patent Application No. 60/762,888, entitled “System and methods permitting the display of images, text and messages on a network of electronic paper-like displays in outdoor modular signs”, filed Jan. 30, 2006, the disclosure of which is incorporated herein by reference.

### BACKGROUND OF THE INVENTION

1. Field of the Invention

This invention relates to outdoor advertising signs or displays and, more particularly, to very lightweight, reflective or emissive sign or display apparatus, a system of a plurality of such apparati, and related methods that allow advertisements and messages on such an apparatus or apparati to be visible outside to consumers so as to reinforce the advertising and to allow the advertisements, etc., to be changed remotely.

2. Description of the Related Art

Electronic signage is an advertising medium commonly deployed in retail outlets and other public areas to display advertising material, and the like. Such signage utilizes a variety of electronic display technologies. Electronic signage is used both indoors and outdoors to display electronic content. Examples of electronic content, or simply content, include text, still images and moving images, such as video, etc.

Indoor electronic signage networks can utilize LED, plasma and LCD flat-screen displays, as well as television and other technologies that emit light, which is seen by the individual viewing the display. These systems are often referred to as “narrow casting” systems and digital signage. Narrowcasting is typically defined as disseminating information to a narrow audience, as opposed to the general public. In out-of-home advertising context specifically, the term generally refers to displaying content in a digital signage network. A widely-known out-of-home narrowcasting system is a television system network that displays advertisements in Wal-Mart®.

In contrast, outdoor electronic signage typically has a much larger display area than indoor electronic signage. The larger sign area allows the displayed content to be seen from greater distances than indoor electronic signage and by a greater number of people. Thus, traditional outdoor electronic signage has not been a narrowcasting medium, but a broadcasting medium. Typical examples of outdoor electronic signage range from the famous electronic billboards in Times Square, to large outdoor LED displays in sports stadiums, to large electronic displays that identify the entrances to shopping malls. Common to all outdoor electronic signage is the need to protect internal electronics from an outdoor environment that typically includes precipitation wind, changing temperature, etc.

Today, outdoor digital signage uses very bright LEDs with extremely fine dot pitch (distance between pixels) and resolution that can be as high as 3200×3200 pixels. This produces large outdoor digital signage with very high quality and excellent color video. Other technologies for outdoor digital signage include plasma and LCD screens when used within outdoor enclosures that sufficiently seal precipitation from moisture-sensitive components, and digital light processing (DLP) reflective devices. These technologies, however, require a large amount of power to maintain the content shown on the electronic displays.

Placement of outdoor electronic signage, as it exists today, depends on the both physical and power concerns. Large, bulky digital signs are both heavy and require a large amount of power to run properly. Therefore, placement of such electronic signage require support structure capable of handling the heavy weight associated with the large displays and protective enclosures and requires proximity to a large power source, such as community generated power via heavy gauge power lines, to supply power to the signs.

In addition, outdoor electronic signage can use satellite, internet and radio waves to transmit content over a large geographic area. Such signage uses software that allows easy content development, scheduling of the advertising on electronic displays and subsequent billing of the advertisers.

These outdoor signs are generally displayed only as single signs at a specific public location such as on a video billboard, at the entrance to a shopping area or on a University campus to provide information. The concept of networking electronic billboards into retail-point-of-purchase displays has been suggested, as in U.S. Pat. No. 6,430,605. However, this patent describes power-intensive, large, expensive electronic billboards that are not utilized in a related manner, such that the message is reinforced with a plurality of digital signs by, for example, repetition or continuity amongst the digital signage, and cannot be placed with several of the signs in close proximity to each other due to, for example, the large size of the displays, the power requirements for each display and the cost of each display.

As mentioned above, the very high cost of today's bright, high-quality LED systems, outdoor plasma systems, outdoor LCD systems and other electronic displays effectively prevents their deployment density to reach a certain level within a predetermined geographic region. Stated another way, this high cost greatly limits the ability to use a large number of outdoor digital signs within a small, well-defined area. For this reason, outdoor electronic signage today is not networked into a group of signs that is in close proximity with each other and that reinforces the content being displayed, for example buying messages and advertisements, is not within a well-defined outdoor area and is not, and cannot be, located near the buying decision point. This prevents the outdoor signage from reinforcing the content, such as advertisements or other types of messages, by displaying coordinated, networked content to consumers that are outdoors, but near a buying location, such as the parking lot of a retail store or mall.

Another problem with conventional outdoor electronic signage is that strong, secure specifically-designed enclosures, needed to protect the electronic signage from environmental concerns and to properly both stabilize and balance the weight associated with the electronic signage, are needed to hold the sign.

As previously suggested, the very high electrical power required by current outdoor digital signage is a serious drawback. For each installation it is necessary to run heavy, industrial power cable to the signage and to insure these lines are not a public hazard. This greatly reduces the ability to deploy a concentrated network of digital signs in a manner that reinforces advertising and messages, and limits the ability to place a network of outdoor digital signage near a retail outlet or within many outdoor public areas.

In sum, the prior art lacks an apparatus, system or related methods allowing outdoor electronic signs to appear with high density within a well-defined outdoor area. Neither is there an apparatus, system or related methods allowing deployment of outdoor electrical signs in close proximity to each other so that all of the signs together would have the same display, at the same time, therefore reinforcing their content, be it advertisement, message or otherwise, with the consumer walking in that area. Such an apparatus, system and method would greatly increase advertising effectiveness.

### SUMMARY OF THE INVENTION

To achieve the foregoing and other objects or purposes of the present invention there is provided numerous low-cost and extremely lightweight outdoor digital signs deployed within a well-defined area and the signs are networked so their content, i.e. advertisements and messages, presented on each display, reinforce each other.

It is still another object to deploy numerous digital signs within a defined area, where each digital sign is used outdoors, by being weather impervious, can be solar and/or battery powered and is lightweight.

It is yet another object to use electronic display technology that mimics paper, or is paper-like, and these paper-like display technologies are characterized as being low cost, and extremely lightweight. This allows a modular sign to be deployed where the modules are electronic paper-like displays, solar panels, battery packs and a sign frame. The modular signs are connected with a wireless interface. They can be installed on existing outdoor infrastructure within a predetermined area, such as parking lot light poles, parking signs, support columns in a parking garage, or awnings. By being mounted on existing infrastructure, the present invention provides coordinated digital signage in the outdoors based upon reflective or emissive display technology. These networked, outdoor signage modules deliver reinforced advertising to consumers walking through the outdoor area where these modular signs are deployed.

It is also an object of the present invention is to provide sign modules that, put together, make a self-contained, extremely lightweight outdoor electronic sign that can be placed on existing infrastructure with similar signs in close proximity to each other.

Another object of the invention is to provide networking capability for the modular signs so that the advertising they display can be changed wirelessly on a predetermined time schedule or, e.g., can be changed, as required, to display public service messages such as instructions during a public emergency.

To achieve the foregoing and other objects/purposes of the present invention, there is provided apparati, systems and methods for displaying content, such as images, text, video, or any other messaging content, over a network of a plurality of modular signs. Each modular sign may contain electronic paper-like displays, solar panels, battery packs, wireless ports and frames for holding the displays.

The lightweight paper-like displays may be reflective, meaning that in outdoor sunlight and brightness they appear to have clarity similar to standard ink or paint on a conventional sign or they may be emissive meaning that they give off light providing luminance to the display. The displays also have a very wide-viewing angle.

The images, text and other advertisement displayed on the electronic paper-like displays can be changed wirelessly from a remote location. This allows the displays to be networked so they all show the same advertisement at the same time, and allows advertisements/messages to be changed or updated frequently using only the wireless connection.

The modular signs are fully contained, weather-resistant, and are very lightweight, allowing them to be mounted outside on existing infrastructure. The modules can be built in different sizes and shapes allowing a high density of signs to be placed in close proximity to each other in an outdoor area. Advertisements are easily updated and changed and are strongly reinforced through the networked sign modules.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principals of the invention.

FIG. 1 is a perspective, front view showing modules on a sign according to one embodiment of the present invention;

FIG. 2 is a rear view of the embodiment shown in FIG. 1;

FIG. 3 is an alternative embodiment of the modular sign according to this invention;

FIG. 4 is a perspective view showing another embodiment of the modular sign;

FIG. 5 is a perspective view showing still another embodiment of the modular sign;

FIG. 6 is a perspective view showing an open clam shell embodiment of the frame of the modular system;

FIG. 7 is a perspective view showing a closed view of the clam shell embodiment shown in FIG. 7;

FIG. 8 is a schematic view of one embodiment of the display and system for controlling the same;

FIG. 9 is a perspective view showing a system of modular signs according to one embodiment of the present invention;

FIG. 10 is a schematic view showing operation of a system of modular signs according to one embodiment of the present invention.

### DETAILED DESCRIPTION OF THE EMBODIMENTS

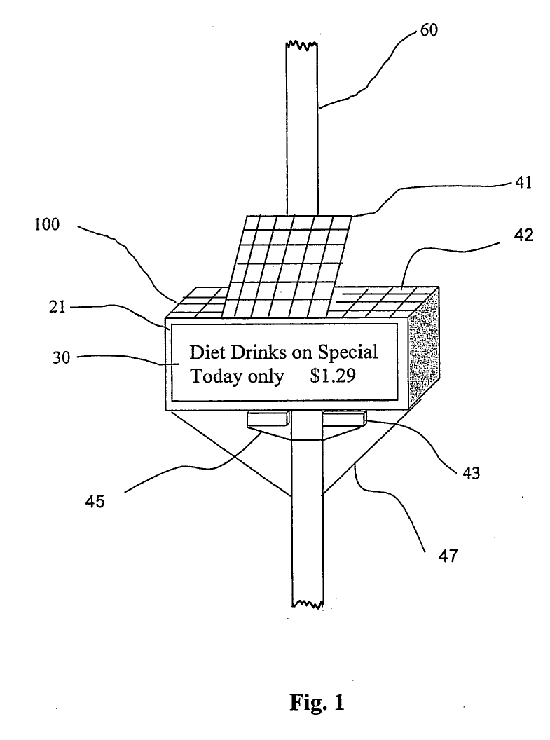

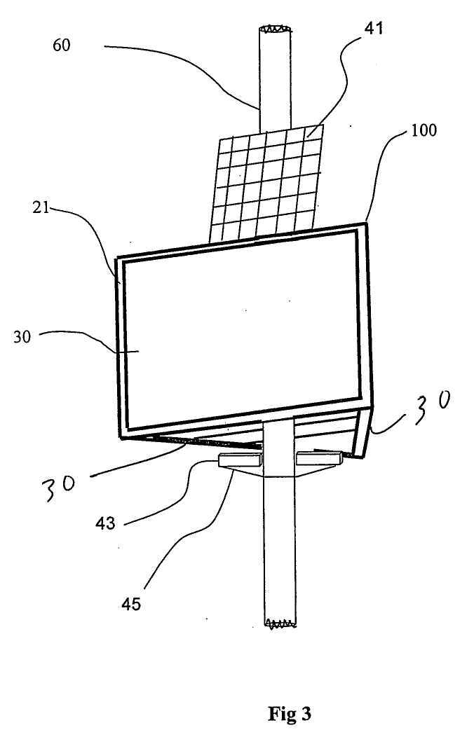

Embodiments of the present invention will now be described with reference to FIGS. 1-10. In this description, certain dimensions are used to assist in understanding the structure of the invention. Of course, one of ordinary skill may use different sized components. As a result, it is not intended that the invention be limited by any particular dimensions.

The present invention is intended for displaying content, such as an advertisement and other forms of messaging, using numerous outdoor modular signs containing electronic paper-like displays, which are located within a well-defined outdoor public area such as the parking lot of a mall or other retail outlet. The invention is also directed to a method and system through which an organization or advertiser can simultaneously display the same content on numerous outdoor modular signs within a well-defined public area such as a parking lot of a mall or other retail outlet.

Referring to the drawings and particularly FIG. 1, there is shown a perspective, front view of one embodiment of the modular sign 100 containing an electronic paper-like display 30 which may exhibit digital content, such as images, video, text and messages used for advertising. In this embodiment, the display 30 takes the form of an electronic paper-like display mounted within, for example, a 3 feet by 2 feet frame 21 providing a viewing area of approximately 33 inches by 21 inches. The frame 21 is the supporting structure for the modules that make up the modular sign 100.

These electronic paper-like displays 30 can be displays that closely resemble the appearance of ink on paper and represent a category of display that is made of very lightweight, flexible or semi-flexible material, most often a plastic, canvas or paper-based material, on which text and images can be displayed and electronically changed. A common, though not comprehensive, feature of such reflective paper-like displays is that the content being displayed does not require electronic power to maintain the display, but only to update the display.

There is a variety of technologies that can be used to create an electronic paper-like display 30 according to the present invention, including light emitting polymer, organic electro-luminescence, organic light emitting displays (OLED), suspended particle device technology, electrophoretic and reverse electrophoretic emulsion display material, bistable nematic technology, high resolution electronic ink, cholesteric and encapsulated cholesteric display materials, electrochromic materials, nanotechnology based materials such as quantum dots, carbon nanotubes or nano-emissive materials, displays printed with various layers of conductive ink, nano ink, nano-metallic ink, carbon nanotube ink, and molecular bistable displays.

Suitable paper-like display modules for display 30 are manufactured by, for example, E-Ink Corporation of Cambridge, Mass., USA., ZDB in the UK and Magink in Israel, Xerox Corporation, Samsung and Bridgestone.

In a preferred embodiment, the electronic paper-like display 30 utilizes a thin sheet of transparent conductive plastic which contains tiny encapsulated particles that respond to an electric charge, changing images and text on the display in much the same way that pixels change an image on conventional electronic displays. E-Ink Corporation produces an example of this type of electrophoretic display. This display is substantively distinguished from conventional electronic screen technology that uses e.g., electron gun stimulated coatings, liquid crystals or the like, active transistors or diode elements, or other such devices, and by there very nature are not analogous thereto. Electronic paper-like display technology was developed in order to overcome some of the limitations of conventional electron display technology, it is easy to read, has a wide viewing angle, and the displays are very lightweight.

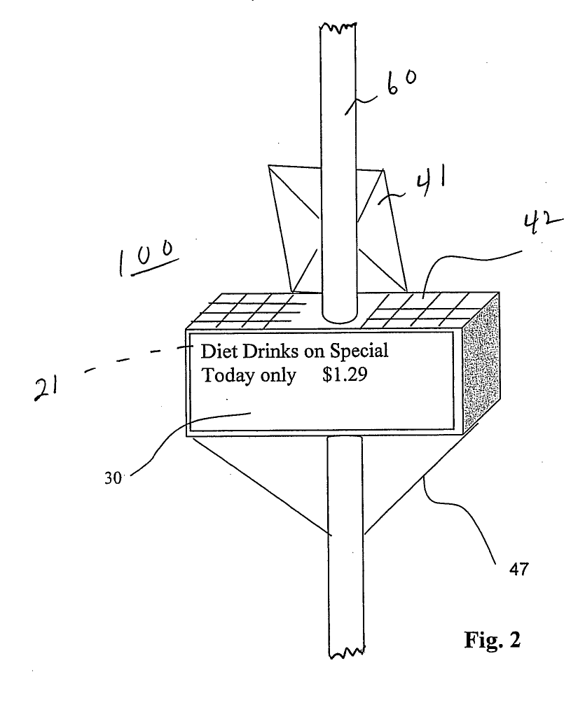

In this embodiment, as shown particularly in FIG. 2, there is an identical display 30 on the opposite side from the one shown in FIG. 1, so that each modular sign 100 contains two electronic paper-like displays 30.

Another benefit provided by electronic paper is that it is not only lightweight, and flexible, but also inexpensive and has low power requirement because, for example, there is no need for a backlight in some implementations (i.e., the display is reflective). Thus, the modular sign 100 can be powered by using a combination of low or fixed output energy sources, such as solar and/or battery power sources. As shown in FIGS. 1 and 2, solar panels 41, 42 and/or battery packs 43 are modules of the modular sign 100.

The relative lightweight of the electronic paper-like displays 30, solar panels 41 and 42, and battery packs 43 allows the modular sign 100 to be mounted on existing infrastructure, such as light poles, utility poles, or support columns. In the embodiment shown in FIGS. 1 and 2, the infrastructure on which the sign module 100 is mounted is a post, such as a light pole 60. For example, as illustrated in FIG. 1, frame connectors 47 mount frame 21 to pole 60 and battery connectors 45 mount battery packs 43 to pole 60.

As an alternative embodiment of a modular sign 100 shown in FIGS. 1-2, FIG. 3 shows a triangular shape, including three sides of frame 21 and three each of display 30 and thereby providing more viewing areas, i.e., three advertising displays per modular sign 100. This affords the opportunity to increase the number of displays for advertising messages per modular sign 100. Of course, more than three displays can be used, as could only one. This alternative embodiment can also be mounted on existing infrastructure 60, e.g. a light pole.

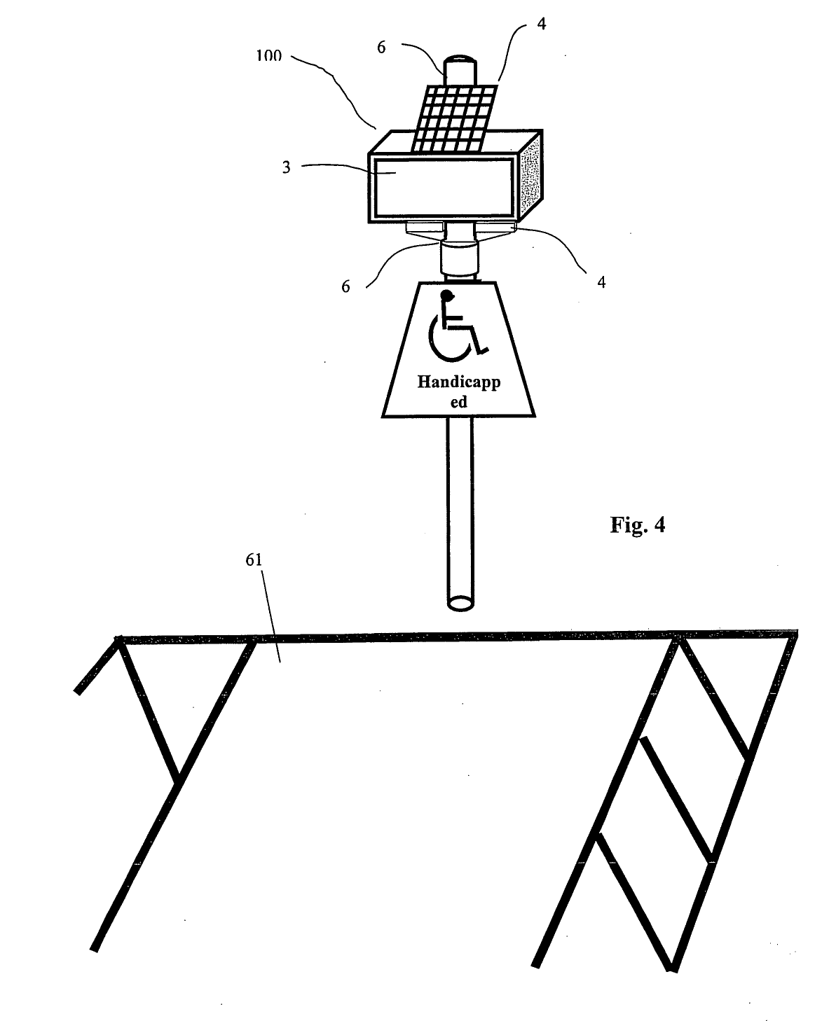

FIG. 4 illustrates a relatively smaller embodiment of the modular sign 100 shown in FIG. 1, including a smaller display area 30, a smaller solar panel 41 and smaller battery packs 43. This smaller sign 100 allows deployment on existing infrastructure 60 with lower size and weight tolerances. For example, in this alternate embodiment the more compact modular sign 100 is placed on sign posts at parking space 61 near the front doors of retail outlets, such as handicap parking or other parking posts, and can be affixed thereto with a pole extension 62 and secured with a collar 64.

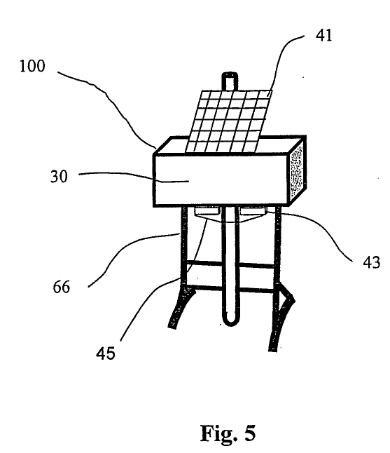

FIG. 5 illustrates an embodiment of another compact modular sign 100 mounted on a portable stand 66 and including display 30, solar panel 41 and battery packs 43. This embodiment can be used, e.g., to extend a network of larger modular signs 100 mounted on existing infrastructure in a parking lot, for example on posts, to a walking area from the parking lot to a retail center or other high traffic public area.

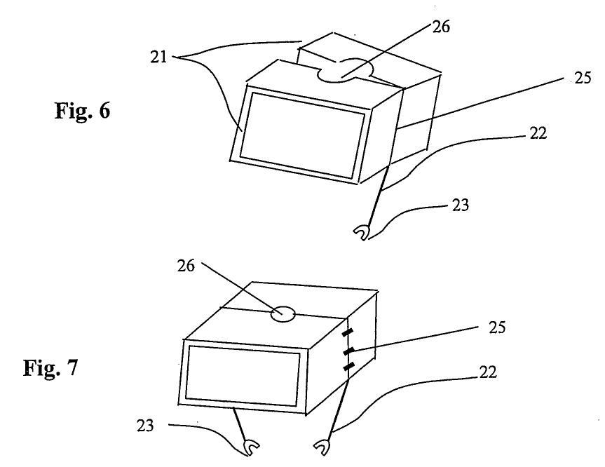

FIGS. 6 and 7 show a preferred embodiment of the frame 21 of the modular sign 100 of FIGS. 1 and 2. The frame 21 is a clam shell arrangement that allows the modular sign 100 to be quickly mounted on, e.g., a existing infrastructure 60, such as a light pole, with braces 22 and clamps 23. A brace 22 and clamp 23 are on each end of the frame 21. That is, the frame 21 pivots around a hinge 25 on one planer side surface of the frame 21 in a manner that allows an opening 26 formed in the frame 21 to receive the pole. In FIG. 7, the frame 21 is shown with the clam shell closed.

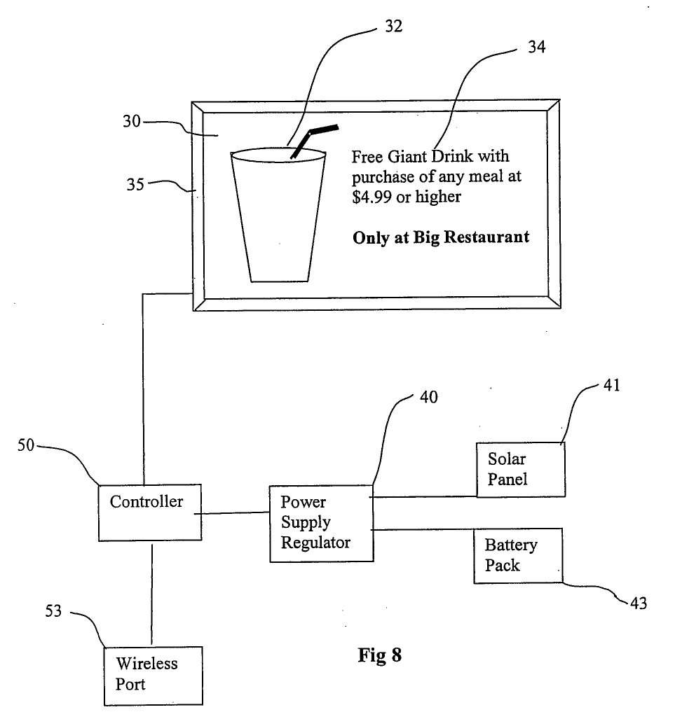

FIG. 8 illustrates operation of the modular sign 100. As shown, the display 30 is received within a display frame 35 that fits either externally or internally on the modular sign frame 21 to from a wall or viewing surface thereof. The system 102 includes a controller 50, a wireless port 53 and a power supply regulator 40 which provides power from either the battery pack(s) 43 or the solar panel(s) 41. Alternative power sources include fuel cells or capacitors. As described, one or more power sources can be used, depending upon the need for backup power (e.g. for important public safety announcements).

In the embodiment shown in FIG. 8, the display 30 may display a mixture of text, image and/or graphical content. For example, display 30 can include regions 32 to correspond with images, and regions 34 to correspond with text, both used in advertising. These regions, 32 and 34, may correspond to differences in the capabilities of the display 30, in which a region may by capable of only displaying text, or alternatively may only be capable of displaying images or graphics.

In operation, content updates, for example advertising and messaging updates, are received through the wireless port 53. Transmission of the content may take various forms and includes transmission from, e.g., a laptop computer, or other portable device, a plurality of stationary transmission stations or from a centralized location, such as a Network Operation Center. The wireless updates create a change to the image and the text in regions 32 and 34, respectively, creating new advertisements and messages.

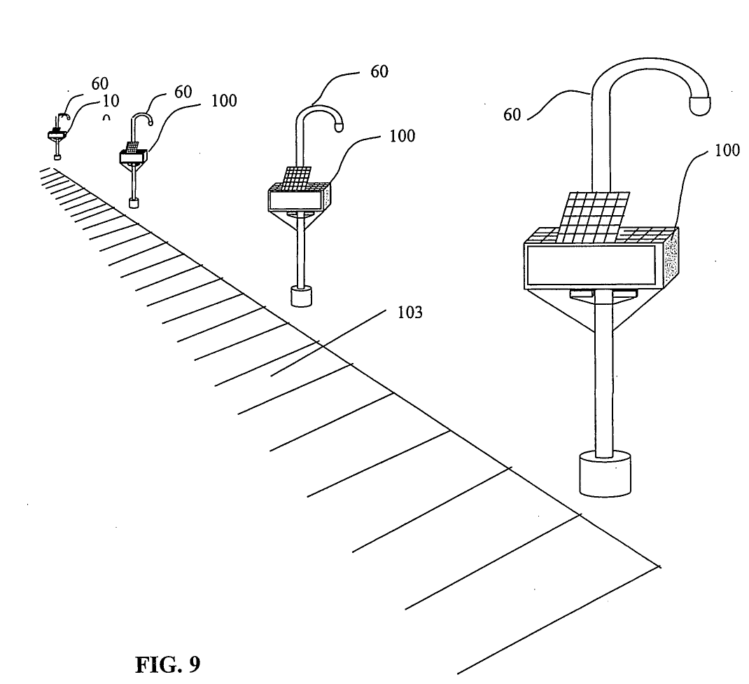

As shown in FIG. 9, the modular sign 100 is well-suited for deployment in the system 102 within a mall parking lot or other retail outlet parking lot, library parking lot and other well-defined public areas. This ability is due to its lightweight, and the excellent visibility of the electronic paper-like display 30 on side(s) of the modular sign 100 and the power availability that is a module component of each sign (e.g., the solar panel module 41 and/or the battery packs 43. Each of the modular signs 100 has a wide viewing angle with no glare when a reflective display technology is used.

The system 102 of the present invention shown in FIG. 9 is placed in a retail parking lot with eight to nine parking spaces 103 between existing infrastructure 60, e.g. a light pole, with a modular sign 100 mounted on each pole 60. Consumers walking from the parking area to the point-of-purchase in a retail shop will pass by numerous of the electronic paper-like displays 30 and see repeatedly the advertisements, thereby reinforcing the same. Alternate embodiments could place the modular signs 100 in other high-volume parking areas, such as airports, theaters, libraries and hotels.

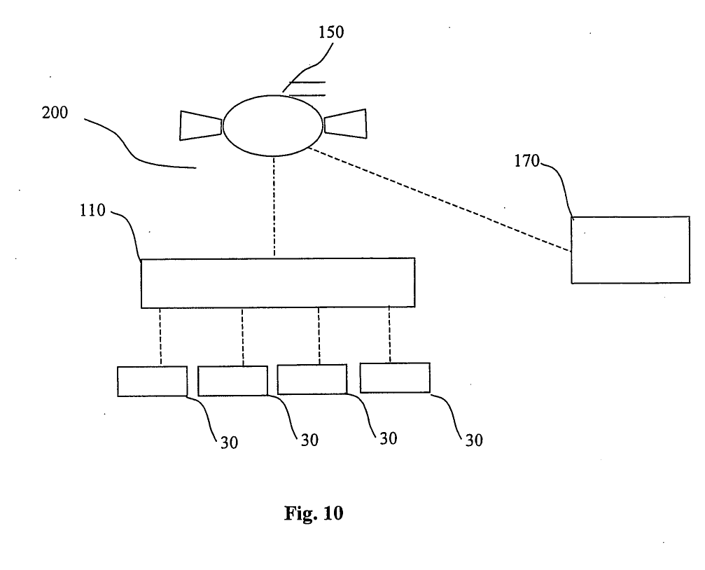

FIG. 10 shows a schematic diagram of a control system 200 for direct placement of commercial advertisements, public service announcements and other content onto a plurality of displays 30. System 200 includes a network including a plurality of electronic paper-like displays 30 that is located within a well-defined outdoor public area such as a parking lot of a mall or other retail outlet. The displays 30 may also be located in other high-volume parking areas such as airports, theaters, libraries and hotels. Hundreds of modular signs may be deployed within each defined area and the plurality of electronic paper-like displays 30 within each modular sign 100 is networked and controlled through a wireless station 110 that is located within the well-defined outdoor area. Again, one or more displays 30 cam be used on each sign 100.

A customer of system 200, for example a consumer products company or an advertising agency, has a contract for time slots for system 200 at a specific geographic area, or for a plurality of systems 200 located at many different and separate geographic areas. Each purchased time slot represents time that an advertisement with text and image or other messages will be displayed on the network of the plurality of electronic paper-like displays 30. The wireless station 110 controls the time allocation on the electronic paper-like displays 30.

In general, the wireless station 110 is a computer server having a satellite transceiver and a wireless transceiver and includes all of the communications and scheduling programs for downloading updated content and time schedules for when this content will be deployed to the network of the plurality of electronic paper-like displays 30. Updated content and time schedules for displaying this content are received via satellite 150 from Network Operating Center 170. In general, the Network Operating Center 170 includes servers, workstations and satellite transceiver and includes suitable computer hardware programmed with suitable software to carry out these functions.

As schedule changes occur based upon downloaded content and time schedules the wireless station 110 will send the updates to the network of a plurality of electronic paper-like displays 30 which receive this data through the wireless port 53 and the image and text in regions 32 and 34, are correspondingly changed.

The wireless station 110 records the time and date of each deployment of new content and this information is periodically uploaded through the satellite transceiver to Network Operating Center 170. This provides verification that advertisements do, in fact, run at the intended time at the intended network of displays. Issues with proper deployment or the lack of appropriate acknowledgement from a modular sign 100 are also transmitted from the wireless station 110 to the Network Operations Center 170.

Customer content, time schedules and deployment areas are provided to the Network Operating Center 170 based upon contracts which specify the requirements for the appropriate operation to be carried out. Databases are connected to a server and store content received from customers, as well as, for example, content scheduling, accounting associated with the contracts to customers and other appropriate information and software for managing the transmission of customer content in accordance with contracts. The software programs, databases and hardware used within the Network Operating Center 170 are available from many vendors.

In view of the above, the apparatus, systems and methods disclosed herein may operate in the following manner. A customer places an order for some content to be delivered to the plurality of modular signs 100, located in the parking lot of a local mall. The customer order is stored in the database at the Network Operations Center 170 and includes the content to be displayed, the times to display the content (e.g. 9:00 am, 12:00 am and 5:00 pm), the length of time to schedule the display of content (three weeks at the above listed times); and to which digital display 30 to transmit the content. Once the accounting information is stored in the database, the scheduling software automatically transmits the content to the digital display(s) 30 specified by the consumer, at the time specified by the consumer, by reading the accounting information stored in the database at regular intervals. For example, the scheduling software may read the database and update the digital signage displays 30 every thirty minutes. When the scheduling software reads that an update is scheduled to occur, the scheduling software selects the appropriate content for display from the database and transmits that content to a wireless station 110 via the satellite transmitter. The content is transmitted using, e.g., the TCP/IP computer networking protocol, up to satellite 150 and back down to Earth, where it is received by the satellite receivers located on each wireless station 110. Wireless station 110 then transmits the content to each display 10 in its range by using a wireless Local Area Network technology, such as IEEE 802.11 b/g/n. Finally, upon receipt of the content, the each display 30 displays the content that it received.

The present invention provides a low weight, high resolution, daylight and wide-angle viewing, compact and modular sign by using an electronic paper-like display with wireless networking capability and the ability to change the images and text on the electronic paper-like display 30 through a wireless port 53.

By using, e.g., TCP/IP, both individual wireless stations and each digital signage apparatus 100 may be communicated to individually by Network Operations Center 170. Thus, all the modular signs 100 serviced by a wireless station or within the system need not receive the same content. This is useful, for example, when the consumer wants to send coordinated content to all the digital signage located in a mall's parking lot and the coordinated content does not use the same images or text at each digital signage apparatus.

Throughout this specification, reference has been made in detail to the presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof.

For example, the displays 30, may include the use of very thin LCD or very low power LCD displays more commonly known as zero power LCD, low power and zero power cholesteric displays, as a module. Other modifications may include the use of flexible OTFT-LCD (organic thin film transistor-liquid crystal display), polythiophene based semi-conductive ink, polymer PEDOT material, conductive polymers and plastics, carbon-nano-tube technology, nano-electronics, nano-powder, displays printed on paper, plastic, fabric, canvas and such material using multiple layers of nanotechnology derived ink, conductive ink, metallic ink and other electronic inks and other types of very thin, lightweight and reflective or emissive displays. Fuel cells as a power module or very thin paper batteries as power modules may also be used or wire can be used to connect power and data to the signs. These other modifications are also within the scope of the present invention. Accordingly, the invention is not limited to that precisely as shown and described in the present application

Furthermore, features illustrated or described as part of one embodiment may be used on another embodiment to yield a still further embodiment. Thus, it is intended that the present invention covers such modifications and variations as come within the scope of the appended claims and their equivalents. Also, the phraseology and terminology used herein is for the purpose of description and should not be regarded as limiting. The invention is capable of other embodiments and of being practiced or of being carried out in various ways.

What is claimed is:

1. A digital signage apparatus, comprising:
an enclosure to protect electronics therein from water damage.
a digital display on said enclosure for displaying, at least one of textual and graphical content;
a first power source for the display connected to said enclosure; and
a connector that mounts said enclosure to an outdoor infrastructure.

2. The apparatus of claim 1, further comprising
a second power source for the display connected to said enclosure;
a receiver, coupled to said digital signage apparatus, receiving electronic transmissions; and
a controller coupled to said digital display and receiver.

3. The apparatus of claim 1, wherein said digital display is at least one of a reflective and an emissive display.

4. The apparatus of claim 1, wherein said first power source includes a solar power panel.

5. The apparatus of claim 1, wherein said second power source includes a stored power source.

6. The apparatus of claim 5, wherein the stored power source is an electrochemical battery

7. The apparatus of claim 1, wherein said first power source includes a fuel cell.

8. The apparatus of claim 2, further comprising:
a Network Operations Center that transmits the content to the digital signage apparatus via a satellite transmitter wherein the receiver coupled to said digital signage apparatus includes a satellite receiver.

9. The apparatus of claim 1, further comprising a plurality of the digital signage apparati mounted on existing infrastructure within a predetermined geographic area.

10. The apparatus of claim 9, wherein the predetermined geographic area is a parking lot and the existing infrastructure includes light poles.

11. The apparatus of claim 9, wherein the predetermined geographic area is a parking garage and the existing infrastructure includes parking garage support columns.

12. The apparatus of claim 9, wherein each of the plurality of digital signage apparati display coordinated content.

13. The apparatus of claim 1, wherein said enclosure is divided into two sections, each section connected pivotally to the other, and each section includes an opening such that when combined, the two sections of said enclosure allow the infrastructure to pass therethrough.

14. A method for displaying at least one of textual and graphical content, comprising:
transmitting the content to mounted outdoor display enclosures;
receiving the content to be displayed at each of the mounted outdoor display enclosures; and
displaying the content via each of the mounted outdoor display enclosures.

15. The method of claim 14, wherein transmitting the content occurs from a single location.

16. The method of claim 14, wherein displaying the content occurs at a predetermined interval.

17. The method of claim 14, wherein the transmitting of the content occurs at a predetermined interval.

18. A digital signage system, comprising:
a wireless transmitter transmitting at least one of textual and graphical content and a storage unit for storing the content;
a plurality of digital signage apparati, each including:
an enclosure sufficient to protect electronics therein from water damage.
a digital display for displaying the content, said display forming an external wall of said enclosure;
a receiver, coupled to said digital signage apparatus, receiving electronic transmissions;
a first power source for said display connected to said enclosure; and
a connector that mounts said enclosure to an external structure.

19. The system of claim 18, wherein said wireless transmitter includes a satellite transmitter for transmitting to said plurality of digital signage apparati the content at a predetermined interval.
